(19) United States
(12) Patent Application Publication
(10) Pub. No.: US 2026/0360775 A1
(43) Pub. Date: Nov. 12, 2026

(54) FUEL CELL SYSTEM AND METHOD

(71) Applicant: Ceres Intellectual Property Company Limited, West Sussex (GB)

(72) Inventor: Scott Nash, West Sussex (GB)

(21) Appl. No.: 19/134,997

(22) PCT Filed: Dec. 12, 2023
(86) PCT No.: PCT/GB2023/053200

§ 371 Date: Jun. 2, 2025

(30) Foreign Application Priority Data
Dec. 13, 2022 (GB) 2218756.1

(51) Int. Cl. H01M 8/04014; H01M 8/04089; H01M 8/04225; H01M 8/04302; H01M 8/04701; H01M 8/04746; H01M 8/0662; H01M 8/22

(52) U.S. Cl. CPC H01M 8/04022; H01M 8/04097; H01M 8/04225; H01M 8/04302; H01M 8/04708; H01M 8/04776; H01M 8/0662; H01M 8/222

(57) ABSTRACT

A fuel cell system, a method of at least partially cracking fuel gas in a fuel cell system, and a method of startup of a fuel cell system. The fuel cell system defining an anode inlet gas fluid flow path for delivering a fuel gas from a first inlet of a recuperative heat exchanger to a first outlet of said recuperative heat exchanger, through a cracker, to a second inlet of said recuperative heat exchanger, to a second outlet of said recuperative heat exchanger and to an anode inlet of at least one fuel cell stack. The fuel cell system having a heat source configured to provide heat to the anode inlet gas fluid flow path between the first outlet of said recuperative heat exchanger and the second inlet of said recuperative heat exchanger. The recuperative heat exchanger arranged to transfer heat from relatively higher temperature at least partly cracked fuel gas from the cracker outlet to relatively lower temperature fuel gas delivered between the first inlet and the first outlet of the recuperative heat exchanger.

### FIELD OF THE INVENTION

The present invention is concerned with improved fuel cell systems and methods.

### BACKGROUND OF THE INVENTION

Fuel cell systems, including fuel cells, fuel cell stacks, fuel cell stack assemblies and heat exchanger systems, arrangements and methods are well known to one of ordinary skill in the art. See, for example, WO2015/004419, which is incorporated herein by reference in its entirety.

Commonly, fuel cells are fueled using hydrocarbons, such as natural gas. With solid oxide fuel cell (SOFC) systems where the fuel cell stack operates in the 400-650 degrees C range—an intermediate-temperature solid oxide fuel cell, or IT-SOFC, or more particularly in the 520-620 degrees C temperature range—still an IT-SOFC, it is necessary to partially reform the fuel in a reformer before the fuel enters the fuel cell as the temperatures in the SOFC are not high enough for efficient internal reforming of the fuel in the SOFC. For this purpose a steam reformer is used in advance of the fuel inlet of the fuel cell stack.

In some cases it is desirable to avoid use of a steam reformer.

It is also desirable to operate fuel fuel cells with other fuels such as ammonia (NH₃)—especially ammonia as a by product of other industrial processes, and fuel cell systems exist in in which ammonia is used as the fuel. See, for example US2014/0072889 and WO2016/114214. However, for many forms of fuel cell, particularly metal supported solid oxide fuel cells, in which the electrochemically active layers of the fuel cell are coated, deposited or mounted on a metal substrate plate (usually steel), or in fuel cell systems where other components of the fuel cell are made of metal, such as steel, including connecting bolts or welds, or in which the electrolyte materials are reactive to, or otherwise likely to deteriorate if exposed to, ammonia—e.g. those containing nickel (Ni), the introduction of ammonia into the stack, especially at the likely operating temperatures of those systems, will create problems. For steel, this can be due to nitriding of the metal, which can lead to failures of the relevant metal-containing components.

The present invention seeks to provide a fuel cell system in which a reformer is not needed and in which other fuels such as ammonia as a fuel can more safely be used.

According to a first aspect of the present invention there is provided a fuel cell system comprising:
(i) at least one fuel cell stack comprising at least one fuel cell, and having an anode inlet, a cathode inlet, an anode off-gas outlet, and a cathode off-gas outlet;
(ii) a cracker for cracking a fuel gas to an at least partly cracked fuel gas, and having a cracker inlet for receiving the fuel gas, and a cracker outlet for exhausting the at least partly cracked fuel gas;
(iii) a recuperative heat exchanger; and
(iv) a heat source;
wherein:
(a) the system defines an anode inlet gas fluid flow path for delivering a fuel gas from a first inlet of said recuperative heat exchanger to a first outlet of said recuperative heat exchanger, through said cracker, to a second inlet of said recuperative heat exchanger, to a second outlet of said recuperative heat exchanger and to said anode inlet of the at least one fuel cell stack;
(b) the heat source is configured to provide heat to the anode inlet gas fluid flow path between the first outlet of said recuperative heat exchanger and the second inlet of said recuperative heat exchanger; and
(c) said recuperative heat exchanger is arranged to transfer heat from relatively higher temperature at least partly cracked fuel gas from the cracker outlet to relatively lower temperature fuel gas delivered between the first inlet and the first outlet of the recuperative heat exchanger, so as to raise a temperature of the fuel gas delivered between the first inlet and the first outlet of the recuperative heat exchanger for delivery to the cracker inlet, whilst reducing the temperature of the at least partly cracked fuel gas from the cracker, between the second inlet and the second outlet of the recuperative heat exchanger for delivery to the anode inlet.

The recuperative heat exchanger has separate flow paths for each fluid—i.e. the fuel gas for cracking (i.e., thermal decomposition preferably in the presence of a suitable catalyst to reduce the temperature at which the cracking/decomposition takes place) and the relatively higher temperature at least partly cracked fuel gas from the cracker, and these fluids, in use, flow simultaneously through the heat exchanger, exchanging heat across the wall(s) separating the flow paths—heating the former fluid and cooling the latter fluid.

With the present invention, the fuel gas may be an ammonia-containing fuel gas in which case it is possible to crack the ammonia before it enters the stack via the anode inlet gas fluid flow path (i.e. a first fluid flow path), whereby instances of nitriding within the stack, and particularly nitriding of the metal components thereof such as the metal substrate plate of a metal supported solid oxide fuel cell, or spacer plates or interconnect plates, or pipes or manifolds within the stack, or the interaction of other reactive or incompatible materials with the ammonia, is reduced or eliminated.

Alternatively, the fuel gas may be a methanol-containing fuel gas in which case it is possible to crack the methanol before it enters the stack via the anode inlet gas fluid flow path (i.e. a first fluid flow path), whereby instances of coking due to decomposition of methanol within the stack, and particularly coking in fluid channels thereof such as within cell units (e.g., on the metal substrate plate of a metal supported solid oxide fuel cell, spacer plates, or interconnect plates), or pipes or manifolds within the stack is reduced or eliminated. Such coking, if not reduced or eliminated, can reduce efficiency of said stacks (and systems therein) by at least partially blocking the anode inlet gas fluid flow path (i.e. a first fluid flow path).

It will be appreciated that the present invention may also be used for other fuel gases, for example methane and higher hydrocarbons, and ethanol and higher alcohols, for similar reasons to those already described with respect to ammonia and methanol.

Furthermore, due to the provision of the recuperative heat exchanger in addition to the cracker, the efficiency of the fuel cell system can be improved as the heat of the heat source can be used in a circular manner, heating up the anode inlet gas fluid flow path that extends through the cracker as it both a) heats the fuel gas in the cracker for the purpose of efficiently maintaining an effective cracking process on the infed (e.g., ammonia-containing or methanol-containing) fuel gas (cracking is an endothermic reaction, and it thus needs a heat source to maintain operational temperatures), and b) heats the product of that endothermic reaction, i.e. the at least partly cracked fuel gas (usually during the reaction, but often after the reaction as well—i.e. while still in the cracker) so that the product of the reaction can be used by the recuperative heat exchanger to pre-heat the fuel gas before that fuel gas enters the cracker. This improves the efficiency of the cracker, by avoiding wastage of heat, and also it improves the operational life of the cracker by reducing the thermal load across the cracker (by pre-heating the infeed).

This recuperative operation also in turn preconditions the product of the reaction (i.e. the at least partly cracked fuel gas from the cracker) before it enters the stack, by way of the source fuel gas cooling it down in the recuperative heat exchanger. This also has benefit since the at least partly cracked fuel gas from the cracker will typically be too hot for the stack, if not cooled, and the present invention's arrangement allows that cooling process to be simultaneous with the pre-heating process for the source fuel gas—thus avoiding, minimising or reducing thermal losses from the system, and parasitic thermal gradients within the components of the system. Fuel cell stacks, after all, usually operate efficiently at a given range of temperatures—and commonly at a temperature below that at which efficient cracking of fuel gas, e.g., ammonia is optimally achieved—particularly the case for IT-SOFCs, where the likely optimum stack temperature is up to 620 degrees C, whereas the desired ammonia cracking temperature may be about 700 degrees C.

The heat source may be configured to directly provide the heat to the anode inlet gas fluid flow path, or it may be configured to indirectly supply that heat to the anode inlet gas fluid flow path.

In some embodiments the fuel gas is an ammonia-containing fuel gas. In some embodiments the ammonia in the ammonia-containing fuel gas may be a by-product of other industrial processes.

In some embodiments the fuel gas is a methanol-containing fuel gas.

In some embodiments the cracker has a catalyst for cracking fuel gas provided on one side of the second heat exchanger, which catalyst forms part of the anode inlet gas fluid flow path.

In some embodiments the recuperative heat exchanger is a counter-flow heat exchanger.

In some embodiments the cracker is arranged to supply or transfer heat from the heat source (preferably an internal heat source disposed within the boundary of the fuel cell system, and typically by way of a heated fluid from the heat source (e.g., via a second fluid flow path configured to convey the heated fluid)) to the anode inlet gas fluid flow path in order to provide the energy for cracking. In some embodiments the heat source is a tail gas burner of the fuel cell system, i.e. an internal tail gas burner, or a catalytic combuster of the fuel cell system, or it could be an external furnace or inline electric heater.

In some embodiments the heat is provided by way of a second heat exchanger preferably as an integral part of the cracker, whereby the cracker comprises the second heat exchanger. However, other forms of cracker are also known, and the heat exchanger for transferring heat to the fuel gas may be separate to the cracker. In some embodiments, for example, the second heat exchanger is between the fuel heat recuperator and the cracker for transferring heat to the recuperative circuit before the fuel heat recuperator. The cracker then needn't comprise a heat exchanger.

In some embodiments, the fuel cell system further comprises a second gas fluid flow path, the heat source configured to provide heat to the second gas fluid flow path, and wherein the fuel cell system is arranged to transfer heat from the second gas fluid flow path to the anode inlet gas fluid flow path (the first gas fluid flow path), so as to provide energy for cracking. It also provides pre-heating for the fuel gas before that cracking for bringing the fuel gas up to temperature for cracking.

In some embodiments the second heat exchanger is a counter-flow heat exchanger, e.g. with parallel flows in opposing directions. A counter-flow heat exchanger means that fuel gas in the anode inlet gas fluid flow path reaches a maximum available temperature at the outlet of the heat exchanger thereby providing the maximum available energy to facilitate cracking.

In some embodiments the second gas fluid flow path comprises an off-gas fluid flow path from the anode off-gas outlet and the cathode off-gas outlet of the stack to the heat source to the cracker. Off-gasses through this second gas fluid flow path are gases that have been heated by having passed through the stack (at an operating temperature T), so the off gases exiting the stack are at an approximate temperature corresponding to that operating temperature T, and the heat source then further heats those gases to an outlet temperature that is more suitable for the cracker. This thus improves the cracking performance (as the cracker's temperature can be optimised) and makes use of the stack's operating temperature T to avoid higher energy demands being required from the heat source (as the off-gases are already pre-heated by the stack).

In some embodiments the second gas fluid flow path extends from the cracker to an exhaust of the fuel cell system. Typically the second gas fluid flow path passes through a third heat exchanger—for example for heating an oxidant for the cathode inlet. This will be after providing heat to the anode inlet gas fluid flow path (i.e. a first fluid flow path) via the cracker.

It will be appreciated that the cracker operates as—or specifically comprises, a heat exchanger arranged to transfer heat from the second gas fluid flow path to the anode inlet gas fluid flow path, so as to provide energy for cracking the fuel gas.

In some embodiments the heat source is disposed upstream of the cracker (within the fuel cell system) in the second gas fluid flow path. In some embodiments it is a tail gas burner of the fuel cell system. In other embodiments it is a catalytic combuster of the fuel cell system. In some embodiments the cracker is a catalytic combustion cracker—for example with an integrated catalytic combustion catalyst. The catalyst may be part of the second heat exchanger, or downstream thereof.

In some embodiments the second heat exchanger—an internal heat exchanger of the cracker, comprises a counter-flow heat exchanger.

In some embodiments the cracker has a catalyst for cracking fuel gas (e.g., a catalyst for cracking ammonia in ammonia-containing fuel gas or a catalyst for cracking methanol in methanol-containing fuel gas) provided on one side of the second heat exchanger typically on a first side, which catalyst forms part of the anode inlet gas fluid flow path. The catalyst is thus on the side of (or in the flow path of) the heat exchanger that is configured to receive the fuel gas.

In some embodiments the system is configured to use off-gases from the anode off-gas outlet and the cathode off-gas outlet when providing the heat source.

In some embodiments the heat source is a tail gas burner (TGB) configured to combust off-gases from the anode off-gas outlet and the cathode off-gas outlet, wherein the off-gas fluid flow path is configured to route combusted off-gas to the cracker (for passing through the heat exchanger of the cracker). As the combusted off-gas has a relatively higher temperature than the temperature of the fuel gas, the cracker is configured to transfer heat from the relatively higher temperature combusted off-gas to the relatively lower temperature fuel gas.

In some embodiments the heat source is a catalytic combustion cracker heat exchanger (CCCHX) configured to catalytically combust off-gases from the anode off-gas outlet and the cathode off-gas outlet, the CCCHX having a catalyst for cracking fuel gas (e.g. ammonia-containing or methanol-containing) coated on the anode inlet gas fluid flow path of the CCCHX and having a catalyst for catalytic combustion of off-gas from the anode off-gas outlet and the cathode off-gas outlet on the off-gas fluid flow path of the CCCHX, the catalytic combustion configured to provide the heat source for cracking the fuel gas (e.g. ammonia in the ammonia-containing fuel gas or methanol in the methanol-containing fuel gas).

In some embodiments a top up line is provided, configured to provide fuel gas, preferably ammonia-containing or methanol-containing fuel gas, and/or oxidant, to the heat source—e.g. the tail gas burner, the catalytic combuster or the CCCHX. The top-up line is typically configured to provide the same fuel gas to the heat source as to the inlet to the recuperative heat exchanger or cracker inlet.

In some embodiments the fuel cell system comprises control software configured to use top up fuel gas to increase a temperature of the off-gas fluid flow path downstream of the heat source.

In some embodiments the off-gas fluid flow path further comprises an oxidant heat exchanger positioned between the cracker and an exhaust of the off-gas fluid flow path, the oxidant heat exchanger configured to provide heat from the off-gas fluid flow path to oxidant, the oxidant configured to be provided to the cathode inlet.

In some embodiments the oxidant is configured to be provided to the cathode inlet via an oxidant fluid flow path from an oxidant source to the cathode inlet.

In some embodiments the system is provided with a bypass around the oxidant heat exchanger such that the off-gas fluid flow path can selectively not pass through the oxidant heat exchanger.

In some embodiments the anode inlet gas fluid flow path further comprises a pipe from said recuperative heat exchanger to the anode inlet, the pipe configured for heat exchange between the at least partly cracked fuel gas and one or both of the at least one fuel cell stack and the heat source. This may be heat transferred from stack to the at least partly cracked fuel gas, or vice versa.

The pipe could be wrapped around the stack or the heat source (e.g. the tail gas burner).

In some embodiments the at least partly cracked fuel gas from the second outlet of the recuperative heat exchanger is fed through a further heat exchanger before entering the stack as a fuel for the stack. The further heat exchanger can further condition the fuel before it is fed into the stack. Usually this will be to heat it, but if the recuperative heat exchanger does not cool the gas to a temperature at or below a desired stack feed temperature, it may be instead arranged to reduce its temperature.

This further heat exchanger may beneficially be a co-flow heat exchanger, rather than a counter-flow heat exchanger, as the heat exchanger will typically be aiming to equalise temperatures between the two fluids, rather than to maximise transfer of heat from one fluid to the other.

In some embodiments the further heat exchanger is thermally connected to the stack, whereby the stack provides heating for the fuel passing through further heat exchanger.

Where provided, the further heat exchanger may be arranged additionally (or instead) to exchange heat between the at least partially cracked fuel gas and oxidant for the stack just before the anode and cathode inlets into the stack. An additional air bypass may be provided to connect the air/oxidant supply to the further heat exchanger.

With the present invention, a tail gas burner or a catalytic combuster is a useful apparatus for providing as the heat source. However, it is not essential for the heat source to be a tail gas burner or a catalytic combuster that is integrated into the fuel cell system. For example, the heat source may be an external heat source or even an electrical heater for feeding heat to the anode inlet gas fluid flow path. Nevertheless, as a tail gas burner or a catalytic combuster is often provided for a fuel cell system, at least one of them is preferred to be provided as the heat source (or as part of the heat source).

In some embodiments the present invention also comprises an ammonia-containing fuel gas source—for example a tank of ammonia-containing fuel gas. In such cases, the cracker has a catalyst for cracking ammonia provided on one side of the second heat exchanger, which catalyst forms part of the anode inlet gas fluid flow path.

In some embodiments an ammonia supply is provided. The ammonia supply may be at least 95% pure ammonia, or a less pure mix of ammonia with other gases, and in particular where the other gases are mainly nitrogen and hydrogen gas. For example, the ammonia supply may be part cracked ammonia.

In some embodiments the present invention also comprises a methanol-containing fuel gas source—for example a tank of methanol-containing fuel gas. In such cases, the cracker has a catalyst for cracking methanol provided on one side of the second heat exchanger, which catalyst forms part of the anode inlet gas fluid flow path.

In some embodiments a methanol supply is provided. The methanol supply may be at least 95% pure methanol, or a less pure mix of methanol with other gases, and in particular where the other gases are mainly nitrogen and hydrogen gas. For example, the methanol supply may be part cracked methanol.

In some embodiments the fuel cell system is an intermediate or high temperature fuel cell system.

In some embodiments the fuel cell system is an intermediate temperature fuel cell system with an operational stack temperature between 400 degrees C and 700 degrees C, particularly 450-650 degrees C, and more particularly 520-620 degrees C.

With the present invention there are usually three stages of heat exchange—heat exchange from the heat source to the fuel gas (for cracking), heat exchange to the supply of fuel gas as fed between the first inlet and the first outlet of the recuperative heat exchanger by the relatively higher temperature at least partly cracked fuel gas from the cracker outlet, and heat exchange to cool that relatively higher temperature at least partly cracked fuel gas by the supply of fuel gas as fed between the first inlet and the first outlet of the recuperative heat exchanger.

In some embodiments the fuel gas fed into the first inlet of the recuperative heat exchanger is provided at a temperature below 60 degrees C and more usually at room temperature (c. 20 degrees C), or at a temperature below room temperature if sourced from a compressed gas supply such as a tank of the gas—due to thermal cooling on expansion before entry into the recuperative heat exchanger.

In some embodiments the fuel cell system comprises a metal supported fuel cell, with its electrochemically active layers coated, deposited or mounted on a metal support or plate. Usually multiple such fuel cells would be stacked to form the stack, as described, for example, in WO2015/004419.

In some embodiments the fuel cell system comprises a solid oxide fuel cell, i.e. the electrochemically active region is a solid oxide. There are many possible forms of SOFC, using different electrochemically active electrolyte chemistries. For example three well known electrolyte materials are yttria-stabilized zirconia (YSZ), scandia stabilized zirconia (ScSZ) and gadolinium doped ceria (GDC or CGO). Ideally it is an intermediate temperature solid oxide fuel cell or IT-SOFC with an operational stack temperature of between 400 degrees C and 700 degrees C. However, in some embodiments the fuel cell system comprises a high temperature fuel cell with an operational stack temperature between 750 degrees C and 1100 degrees C.

In some embodiments flame combustion is used for providing the heat source. Typically the flame combustion occurs in a tail gas burner of the fuel cell system—for example connected to the anode off-gas outlet and the cathode off-gas outlet of the fuel cell stack. In some embodiments catalytic combustion is used for providing the heat source. Typically the catalytic combustion occurs in a catalytic combustor of the fuel cell system—for example connected to the anode off-gas outlet and the cathode off-gas outlet of the fuel cell stack.

In some embodiments the heat source and the cracker are separate units of the fuel cell system, connected by pipework. For example, the heat source may comprise a hot gas output port and the cracker may comprise a hot gas input port that is fluidly connected to the heat source's hot gas output port.

In some embodiments the heat source and the cracker are combined into a single integrated unit.

In some embodiments the heat source and the cracker are combined as a catalytic combustion-cracker heat exchanger (CCCHX).

In some embodiments, a bypass or variable valve to provide flow control is provided between the heat source and the cracker for bypassing or reducing/varying flow of heat from the heat source to the cracker. For example, a bypass from the heat source may be provided to allow at least a portion of the heat from the heat source to be diverted for alternative operations, or to entirely bypass heating the anode inlet gas fluid flow path within the cracker. Alternatively the flow-rate from the heat source may be controlled to reduce the heat transfer rate. The bypass or flow-rate may be controlled by a controller for maintaining a desired temperature for the output of the at least partly cracked fuel gas from the cracker outlet. For example, if the cracker output is to be increased in temperature, the full (or a larger proportion of) flow from the heat source can be passed to the cracker, but if the temperature of the cracker output is to be reduced, then some or all of the flow from the heat source can be diverted or slowed down.

In some embodiments the bypass allows some of the heat from the heat source to be utilised elsewhere in the system, or by other nearby equipment—particularly equipment requiring higher heat input than the exhaust flowing from the cracker.

In some embodiments the cracker is intended to operate at between 550 degrees C and 900 degrees C, preferably between 650 degrees C and 900 degrees C, more preferably between 650 degrees C and 750 degrees C and most likely at about 700 degrees C when at its steady operational state. In some embodiments, however, it runs at between 550 degrees C and 600 degrees C when at its steady operational state.

In some embodiments the fuel gas is an ammonia-containing fuel gas and cracking of the ammonia-containing fuel gas is targeting less than 1000 parts per million of ammonia for the fuel to be fed to the stack. Operating temperatures at or in excess of 700 degrees C have been shown to readily achieve this. With some crackers, 700 degrees C equates to 231 ppm at the output. Some such catalysts would preferably run at 650-700 degrees C and still provide confidence that it will achieve <1000 ppm at desired fuel flow rates for the stack.

These temperatures are the peak temperatures of the fuel gas within the cracker.

Typically 700 degrees C is higher than the operating temperature of the stack in an intermediate fuel cell system (e.g. a metal-supported solid-oxide fuel cell system), but the heat source is chosen to provide the desired temperatures within the cracker, such as between 650 degrees C and 750 degrees C, or preferably in excess of 700 degrees C. In some embodiments, however, it runs at between 550 degrees C and 600 degrees C when at its steady operational state.

In some embodiments the fuel gas is a methanol-containing fuel gas and cracking of the methanol-containing fuel gas is targeting less than 1000 parts per million of methanol for the fuel to be fed to the stack. Operating temperatures at or in excess of 700 degrees C have been shown to readily achieve this. Some catalysts would preferably run at 300-400 degrees C and still provide confidence that it will achieve <1000 ppm at desired fuel flow rates for the stack. As such, the methanol-containing fuel gas (and cracking thereof) is particularly advantageous for a PEM fuel cell stack/system. Such PEM fuel cell stacks/systems operate at lower temperatures than those required for methanol cracking, but the heat source may nevertheless supply the heat required for cracking.

In some embodiments the fuel cell system has an anode off-gas recirculation path configured to recycle a portion of anode off-gas from the anode off-gas outlet of the at least one fuel cell stack to the anode inlet of the at least one fuel cell stack. This may increase overall system efficiency.

In some embodiments, the anode off-gas recirculation path comprises a getter configured to remove uncracked fuel gas from the anode off-gas recirculation path. This reduces the proportion of uncracked fuel gas in routed the to anode inlet of the at least one fuel cell stack and may increase overall system efficiency.

According to a further embodiment of the present invention there is provided a fuel cell system comprising:
(i) at least one fuel cell stack comprising at least one fuel cell, and having an anode inlet, a cathode inlet, an anode off-gas outlet, and a cathode off-gas outlet;
(ii) a cracker for cracking a fuel gas to an at least partly cracked fuel gas, and having a cracker inlet for receiving the fuel gas, and a cracker outlet for exhausting the at least partly cracked fuel gas;
(iii) a recuperative heat exchanger; and
(iv) a heat source;
wherein:
(a) the system defines an anode inlet gas fluid flow path for delivering a fuel gas from a first inlet of said recuperative heat exchanger to a first outlet of said recuperative heat exchanger, through said cracker, to a second inlet of said recuperative heat exchanger, to a second outlet of said recuperative heat exchanger and to said anode inlet of the at least one fuel cell stack;
(b) the heat source is configured to provide heat to the anode inlet gas fluid flow path between the first outlet of said recuperative heat exchanger and the second inlet of said recuperative heat exchanger; and
c) a bypass or variable valve to provide flow control is provided between the heat source and the cracker for bypassing or reducing/varying flow of heat from the heat source to the cracker.

In some embodiments the bypass allows at least a portion of the heat to be diverted away from the cracker for alternative use.

This system may also be in accordance with the preceding system.

The present invention also provides a method of at least partially cracking fuel gas, comprising providing a system as defined above, flowing fuel gas through the anode inlet gas fluid flow path, and providing heat via the heat source to the anode inlet gas fluid flow path between the first outlet of said recuperative heat exchanger and the second inlet of said recuperative heat exchanger.

With the present invention, upon commencement of cracking, the method at least partially cracks the fuel gas in the cracker. In a preferred embodiment this is achieved while delivering heat from the heat source through the cracker, although the heat might instead be provided to the (e.g. ammonia-containing) fuel gas external of the cracker. The provision of the heat to the anode inlet gas fluid flow path may be direct or indirect.

In some embodiments the cracker has an operational temperature of between 550 degrees C and 900 degrees C, preferably between 650 degrees C and 900 degrees C and more preferably between 650 degrees C and 750 degrees C, and most likely at about 700 degrees C. This operational temperature particularly applicable to ammonia-containing fuel gas and is the peak temperature to which the ammonia-containing fuel gas is raised within the cracker during normal operations. A skilled person will appreciate that during warm up, the cracker would initially be exposed to room temperatures, and up from that during the warm-up cycle.

In some embodiments in which the fuel gas is an ammonia containing fuel gas the at least partially cracked fuel gas exiting the cracker contains less than 1000 parts per million of ammonia.

In some embodiments in which the fuel gas is a methanol-containing fuel gas, the cracker may have an operational temperature as outlined above, but may advantageously have an operational temperature of between 250 degrees C and 450 degrees C, preferably between 300 degrees C and 400 degrees C. In such cases, it may preferably be used in a PEM fuel cell system. In such cases, the at least partially cracked fuel gas exiting the cracker may contain less than 1000 parts per million of methanol.

In some embodiments the heat source is configured to combust off-gases from the anode off-gas outlet and the cathode off-gas outlet, and the off-gas fluid flow path is configured to route combusted off-gas to the cracker at a relatively higher temperature than the fuel gas, the cracker being configured to transfer heat from the relatively higher temperature combusted off-gas to the relatively lower temperature fuel gas.

In some embodiments there are three stages of heat exchange—heat exchange from the heat source to the fuel gas, heat exchange to the supply of fuel gas as fed between the first inlet and the first outlet of the recuperative heat exchanger by the relatively higher temperature at least partly cracked fuel gas from the cracker outlet, and heat exchange to cool that relatively higher temperature at least partly cracked fuel gas by the supply of fuel gas as fed between the first inlet and the first outlet of the recuperative heat exchanger.

In some embodiments the fuel gas fed into the first inlet of the recuperative heat exchanger is provided at a temperature below 60 degrees C and more usually at room temperature (c. 20 degrees C), or at a temperature below room temperature if sourced from a compressed gas supply such as a tank of the gas—due to thermal cooling on expansion before entry into the recuperative heat exchanger.

In some embodiments the cracking of the fuel gas is targeting less than 1000 parts per million of, for example, ammonia for the fuel to be fed to the stack. Operating temperatures at or in excess of 700 degrees C have been shown to achieve this. Testing has shown that with some crackers, at equilibrium, 525 °C can achieve ≤1000 ppm, with temperatures higher than this achieving a lower ppm at the outlet of the cracker. With some crackers, 700 degrees C equates to 231 ppm at the output. Typical catalysts, however, would more preferably run at 650-700 degrees C to provide confidence that it will achieve <1000 ppm at desired fuel flow rates for the stack.

These temperatures are the peak temperatures of the fuel gas within the cracker.

Typically 700 degrees C is higher than the operating temperature of the stack, but the heat source is chosen to provide the desired temperatures within the cracker, such as between 650 degrees C and 750 degrees C, or preferably in excess of 700 degrees C. In some embodiments, however, it runs at between 550 degrees C and 600 degrees C when at its steady operational state.

The present invention also provides a method of start-up of a fuel cell system as described above, comprising
providing oxidant and top up fuel to the heat source to produce a hot exhaust gas;
using heat from the hot exhaust gas to provide heat via an oxidant heat exchanger to pre-heat oxidant for feeding to the cathode inlet of the stack; and
once the a pre-determined part of the stack reaches a first threshold temperature, commencing (or increasing a rate of) a flow of the fuel gas through the anode inlet gas fluid flow path.

The present invention also provides a method of start-up of a fuel cell system, the fuel cell system comprising:
at least one fuel cell stack with an oxidant inlet and a fuel inlet,
an oxidant heat exchanger for an oxidant flow to the oxidant inlet of the stack,
a heat source for heating the at least one fuel cell stack, and
a cracker for cracking an fuel gas to an at least partly cracked fuel gas, the cracker having a cracker inlet for receiving the fuel gas and a cracker outlet for exhausting the at least partly cracked fuel gas for feeding to the fuel inlet of the stack,
the method comprising:
heating the at least one fuel cell stack to a first threshold temperature; and
once the at least one fuel cell stack reaches a first threshold temperature, either commencing or increasing a rate of a flow of the fuel gas to the cracker.

The heat source (or a different heat source, e.g. if more than one heat source is provided) can heat the cracker and/or the fuel gas.

The method may comprise:
providing oxidant and top up fuel to the (or a different) heat source to produce a hot exhaust gas;
using heat from the hot exhaust gas to provide heat via the oxidant heat exchanger to pre-heat oxidant for feeding to the oxidant inlet of the stack; and
once a predetermined part of the fuel cell system reaches the first threshold temperature, commencing (or increasing a rate of) the flow of the fuel gas to the cracker.

The present invention also provides a method of start-up of a fuel cell system, the fuel cell system comprising:
at least one fuel cell stack with an oxidant inlet and a fuel inlet,
an oxidant heat exchanger for an oxidant flow to the oxidant inlet of the stack,
a heat source and
a cracker for cracking a fuel gas to an at least partly cracked fuel gas, the cracker having a cracker inlet for receiving the fuel gas and a cracker outlet for exhausting the at least partly cracked fuel gas for feeding to the fuel inlet of the stack,
the method comprising:
providing oxidant and top up fuel to the heat source to produce a hot exhaust gas;
using heat from the hot exhaust gas to provide heat via the oxidant heat exchanger to pre-heat oxidant for feeding to the oxidant inlet of the stack; and
once a predetermined part of the fuel cell system reaches a first threshold temperature, commencing (or increasing a rate of) a flow of the fuel gas to the cracker.

In each method, the fuel cell system is preferably as defined above.

In some embodiments the predetermined part is a part of the stack. In another embodiment it may be a part of the cracker.

In some embodiments, the oxidant is provided to the heat source via an oxidant fluid flow path from an oxidant source to the stack's oxidant or cathode inlet, through the stack and out from the stack's cathode off-gas outlet to the heat source.

In some embodiments the heat source is a tail gas burner or a catalytic combuster connected to the stack's anode off-gas outlet and cathode off-gas outlet.

In some embodiments the predetermined part is at a location along an off-gas fluid flow path between the stack's anode off-gas outlet or cathode off-gas outlet and the oxidant heat exchanger. The off-gas fluid flow path typically passes through the cracker, although in some embodiments it may selectively bypass it.

In some embodiments the predetermined part is a part of the cracker, such as the cracker's cracker outlet. The first threshold temperature may than be a temperature at or between 700 and 800 degrees C. The commenced flow of fuel gas to the fuel cell system's anode inlet gas fluid flow path can then be effectively cracked in the cracker before passing into the stack.

In some embodiments, after commencing the flow of the fuel gas to the cracker, the method comprises gradually increasing the flow rate of fuel gas to the cracker.

In some embodiments, after commencing the flow of the fuel gas to the cracker, the method comprises decreasing a flow rate of top up fuel. In some embodiments the decrease in the rate of top up fuel may start at same time as commencing the flow of fuel gas, although there can instead be a lag between them.

In some embodiments the method comprises controlling a gradual increase in the flow rate of the fuel and/or a gradual decrease in the flow rate of the top-up fuel to keep the predetermined part of the fuel cell system at or above the first threshold temperature. In other embodiments the method comprises controlling a gradual increase in the flow rate of the fuel and/or a gradual decrease in the flow rate of the top-up fuel to keep a predetermined location of the off-gas fluid flow path at or above a predetermined temperature. Preferably that temperature is at or between 700 degrees C and 800 degrees C. In some embodiments, the predetermined location is instead or additionally a position in or on the fuel cell system's fuel heat recuperator—for example the temperature of the at least partially cracked fuel prior to or at the second inlet of the recuperative heat exchanger. That location's temperature may want to be maintained at T>500 degrees C.

In some embodiments the first threshold temperature is the inlet temperature for the fuel cell, and it may be at or between 400 degrees C and 500 degrees C, or more preferably at about 450 degrees C (e.g. for the fuel or for the oxidant or both).

The present invention thus also provides flow of fuel through the heat source—typically a tail gas burner or catalytic combuster—via a top up—to warm up the system from room/ambient temperature.

With the present invention there can be multiple warm-up phases. For example, from a cold start there is an initial preheat using the oxidant and top-up fuel. Then, when at a first given predetermined temperature, e.g. when an air stack inlet or outlet temp reaches 450 degrees C, the method may comprise slowly introducing fuel through the cracker and stack, to move to a fuel assisted warm up phase.

An air stack inlet or outlet temp of circa 450-500 degrees C then allows a current to start being drawn from the stack. This then becomes a current assisted warm up phase.

Then, when an air stack outlet temperature reaches about 600 degrees C, that may be used to indicated that the fuel cell system has transitioned to a substantially steady state operating point.

The present invention will now be described in further detail, purely by way of example, with reference to the accompanying drawings in which:

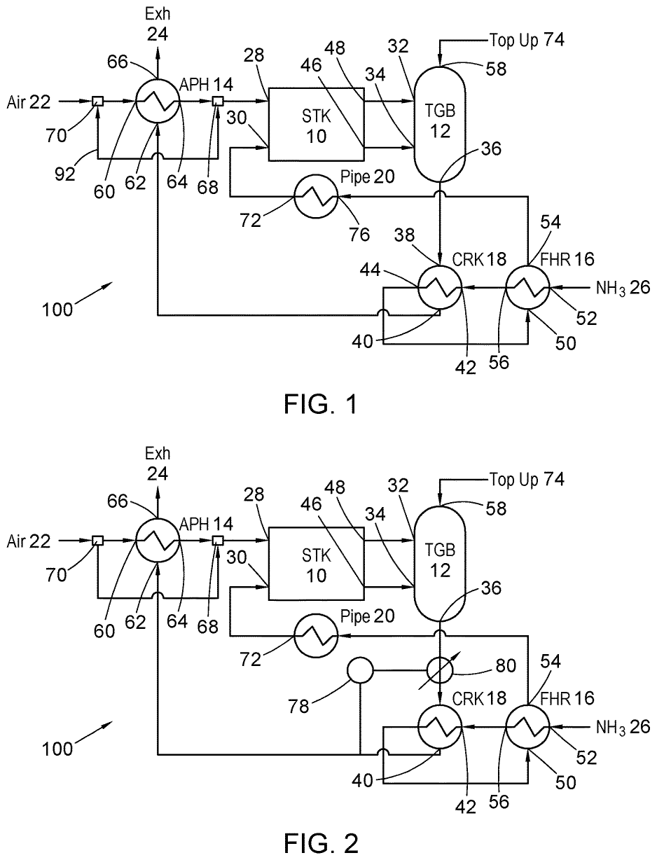

FIG. 1 schematically shows a first fuel cell system according to the present invention, with an air pre-heater, a fuel heat recuperator and an ammonia cracker, using a tail gas burner as a heat source for the ammonia cracker;

FIG. 2 schematically shows a modified version of the fuel cell system of FIG. 1, with a bypass or variable valve to provide flow control between the heat source and the ammonia cracker for bypassing or reducing/varying flow of heat from the heat source to the cracker;

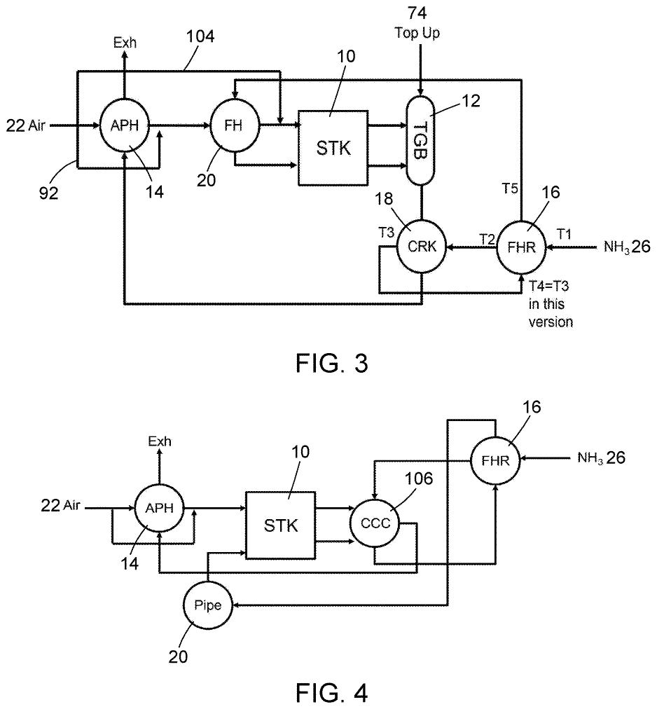

FIG. 3 schematically shows another modified version of the fuel cell system of FIG. 1, incorporating an alternative configuration for its fuel supply to its fuel cell stack, with a fuel heater (or heat exchanger) for supplying heat to (or exchanging heat between) the oxidant for the stack and the fuel for the stack;

FIG. 4 schematically shows an alternative fuel cell system in accordance with the present invention, in which a combined catalytic combustion cracker is used in place of the separate tail gas burner and ammonia cracker of FIG. 1;

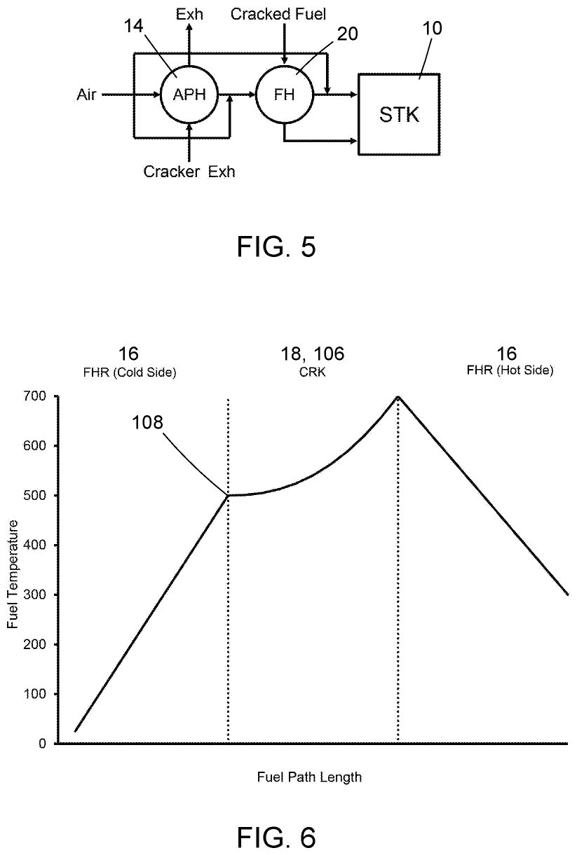

FIG. 5 schematically shows the modification of FIG. 3 for applying to the embodiment of FIG. 4;

FIG. 6 shows a graph that schematically represents an example of the fluid temperature of ammonia/cracked ammonia, as fed to and through the ammonia cracker, from when it first passes into the fuel heat recuperator, through the ammonia cracker and again through the fuel heat recuperator, prior to passing to the stack;

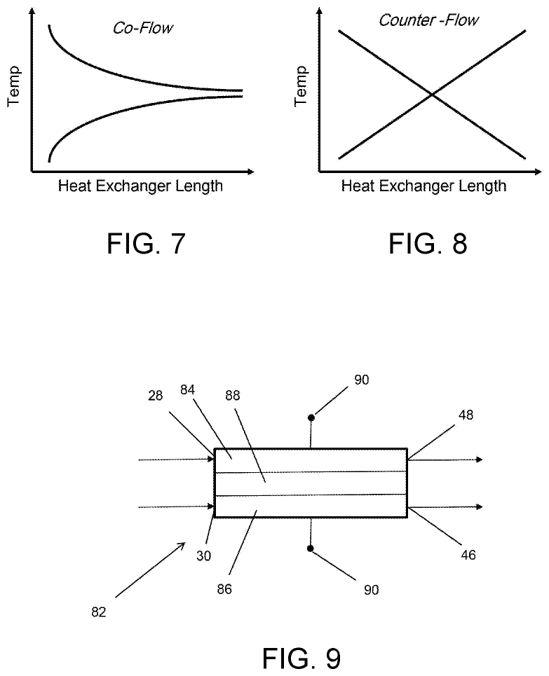

FIGS. 7 and 8 schematically show relative operational fluid temperatures of fluids passing through a co-flow heat exchanger and a counter-flow heat exchanger, respectively;

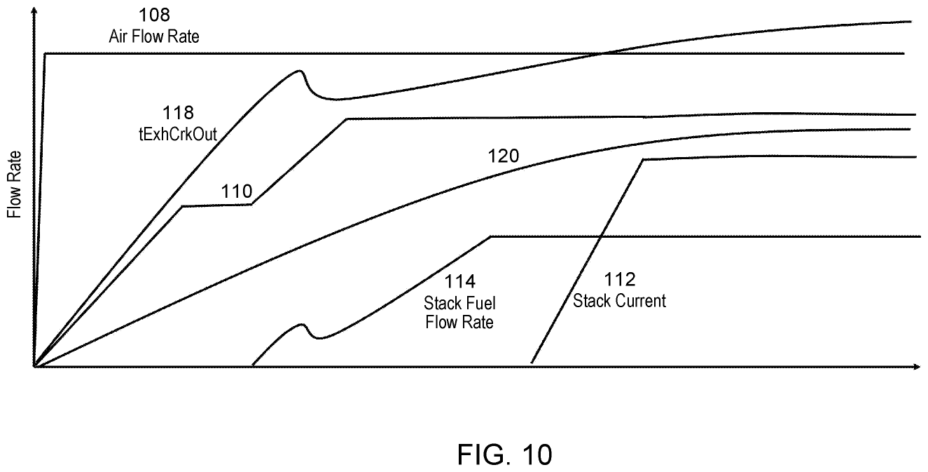

FIG. 9 schematically shows a typical fuel cell, multiples of which may be stacked in a fuel cell stack;

FIG. 10 schematically provides a graphical representation over time of various inputs and outputs to or from the fuel cell system of the present invention, such as fluid flow rates, temperatures and electrical currents, during system start-up or during a warm-up cycle;

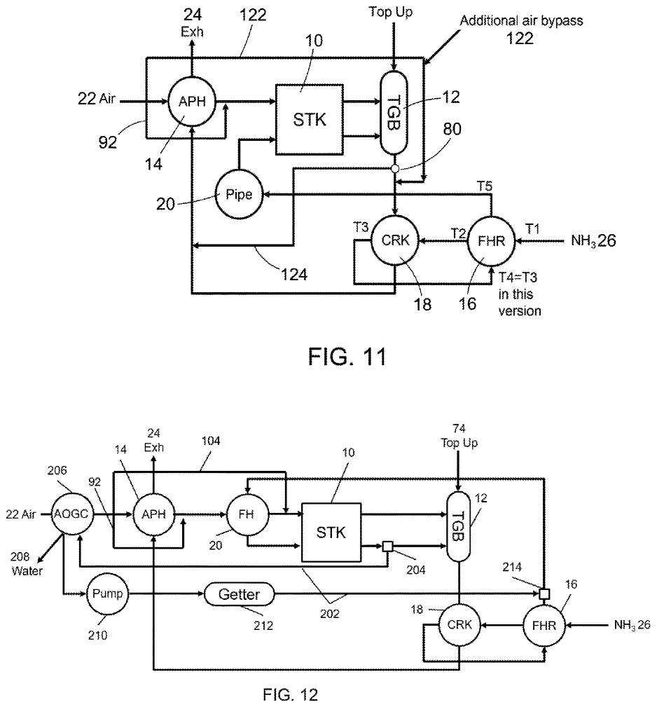

FIG. 11 schematically shows an optional modified configuration for the fuel cell system of FIG. 1 during the system start-up or warm-up cycle; and

FIG. 12 schematically shows a modified configuration for the fuel cell system of FIG. 3.

Referring first of all to FIG. 1 there is schematically shown a fuel cell system 100 according to the present invention. The fuel cell system 100 is exemplified by reference to an ammonia-containing fuel gas. The fuel cell system 100 comprises a fuel cell stack 10, a heat source 12, an air pre-heater 14, a fuel heat recuperator 16, an ammonia cracker 18 and a fuel temperature pre-conditioner 20. In this embodiment, the heat source 12 is a tail gas burner 12 connected to the stack 10 and the fuel temperature pre-conditioner 20 is a heat exchanger 20, which may be in the form of a pipe wrapped around the stack or some other hot or cold object—dependent upon whether the fluid passing therethrough to the stack 10 is to be heated or cooled.

The fuel cell stack 10 comprises at least one fuel cell 82, for example as shown in FIG. 9, and has an oxidant (usually cathode) inlet 28, a fuel (usually anode) inlet 30, an oxidant (usually cathode) off-gas outlet 48, and a fuel (usually anode) off-gas outlet 46. The or each fuel cell 82 is formed from a cathode layer 84, an anode layer 86 and an electrochemically active layer 88, and may, for example, be as described in WO2015/004419.

As shown in FIG. 9, during the operation of the fuel cell system 100, oxidant (usually air 22) enters the fuel cell/stack 10, 82 at the oxidant inlet 28, fuel enters the fuel cell/stack 10, 82 at the fuel inlet 30, cathode off-gas exits the fuel cell/stack 10, 82 from the oxidant off-gas outlet 48 and anode off-gas exits the fuel cell/stack 10, 82 at the anode off-gas outlet 46, and a DC electrical charge can be taken from the fuel cell/stack 10, 82 at terminals 90 at the ends (here top and bottom) of the stack 10. Such operational characteristics of a fuel cell/stack are well known in the art.

The heat source 12 in FIG. 1 is a tail gas burner 12. This takes the anode and cathode off-gases from the fuel cell/stack 10, 82 and flame combusts them together to produce a heat output. This heat output—usually a hot exhaust gas—vents from the tail gas burner 12 though a heat outlet 36 of the tail gas burner 12.

The heat output (hot exhaust gas) then passes to the cracker 18 to provide heat for the cracker 18 at a heat input 38 of the cracker 18.

The cracker 18 is for cracking an ammonia-containing fuel gas. That gas is delivered thereto from an ammonia source 26, which may be from a neighbouring separate process apparatus that produces ammonia, a stored tank of ammonia, or an ammonia supply pipeline.

The ammonia-containing fuel gas is delivered to the cracker 18 at a cracker inlet 42 of the cracker 18, and exits the cracker 18, after being processed by the cracker 18, as an at least partly cracked fuel gas at a cracker outlet 44 of the cracker 18.

From the cracker outlet 44, the at least partly cracked fuel gas is fed to the recuperative heat exchanger 16 at a fuel recuperation inlet 50 of the recuperative heat exchanger 16. As the at least partly cracked fuel gas is still hot when it exits the cracker 18, its heat can be used by the recuperative heat exchanger 16 to pre-heat the ammonia-containing fuel gas before the ammonia-containing fuel gas enters the cracker, i.e. the recuperative heat exchanger 16 is downstream of the cracker 18. The recuperative heat exchanger 16 is also positioned upstream of the cracker 18, and the ammonia-containing fuel gas first enters the recuperative heat exchanger 16 at a fuel source inlet 52 of the recuperative heat exchanger 16, before then being heated by the heat of the at least partly cracked fuel gas in that recuperative heat exchanger 16, before then exiting the recuperative heat exchanger 16 at a pre-heated ammonia outlet 56 of the recuperative heat exchanger 16. The now pre-heated ammonia-containing fuel gas can then be passed into the cracker 18, as above, via the cracker inlet 42.

The at least partly cracked and part-cooled fuel gas can thereafter exit the recuperative heat exchanger 16 via a fuel outlet 54 of the recuperative heat exchanger 16 for passing towards the fuel inlet 30 of the stack 10.

In this embodiment, before that at least partly cracked and part-cooled fuel gas enters the stack, it passes through the fuel temperature pre-conditioner 20, which as described above is a heat exchanger 20 in this embodiment—preferably in the form of a pipe wrapped around the stack, or some other hot object, so that the at least partly cracked and part-cooled fuel gas can be pre-conditioned to the correct temperature for entering the stack—typically it is heated in the fuel temperature pre-conditioner 20 by the heat of the stack, although in some embodiments this may instead be required to be further cooled instead, e.g. using a heat sink or routing the pipe near colder components for additional heat loss.

This flow path for the ammonia—before and after cracking, up to the fuel inlet 30, is a first gas fluid flow path, also referred to as—an anode inlet gas fluid flow path which connects the fuel heat recuperator 16, the cracker 18, the fuel heat recuperator 16 again, the fuel temperature pre-conditioner 20 and the stack 10 for delivering an ammonia-containing fuel gas from a first inlet 52 of said recuperative heat exchanger 16 to a first outlet 56 of said recuperative heat exchanger 16, through said cracker 18, to a second inlet 50 of said recuperative heat exchanger 16, to a second outlet 54 of said recuperative heat exchanger 16 and to said anode inlet 30 of the at least one fuel cell stack 10. Furthermore, the heat source 12 is configured to provide heat to the anode inlet gas fluid flow path in the cracker 18, and thus between the first outlet 56 of said recuperative heat exchanger 16 and the second inlet 50 of said recuperative heat exchanger 16.

In accordance with the present invention, said recuperative heat exchanger is arranged to transfer heat from the relatively higher temperature at least partly cracked fuel gas from the cracker outlet 44 to a relatively lower temperature ammonia-containing fuel gas delivered from the ammonia source 26 between the first inlet 52 and the first outlet 56 of the recuperative heat exchanger 16, so as to raise the temperature of the ammonia-containing fuel gas delivered to the recuperative heat exchanger 16, that temperature increase happening to the ammonia-containing fuel gas between the first inlet 52 and the first outlet 56 of the recuperative heat exchanger 16, ready for delivery to the cracker inlet 42, whilst reducing the temperature of the at least partly cracked fuel gas from the cracker 18, between the second inlet 50 and the second outlet 54 of the recuperative heat exchanger 16, for subsequent delivery to the anode inlet 30 of the stack 10.

In this embodiment, the cracker 18, after using some of the heat of the hot exhaust gas, vents the hot exhaust gas via a heat outlet 40 of the cracker 18 for subsequent use by an air pre-heater 14 of the fuel cell system 100, whereafter it exits the system 100 at an exhaust 24. This fluid flow path is a second gas fluid flow path.

The air pre-heater 14 is provided to pre-heat the oxidant (e.g., air or oxygen) for the stack 10. By pre-heating air from an air source 22, by feeding that air through the air pre-heater, the stack is exposed to less thermal shock. Likewise, by pre-heating the the ammonia-containing fuel gas, the cracker 18 is exposed to less thermal shock. Efficiencies of the system can also be increased by using the off-gases of the stack to provide heat for the cracker, which heat can also provide the air pre-heating and the ammonia-containing fuel gas pre-heating. Furthermore, the stack can also provide a degree of pre-heating or pre-conditioning of the fuel for the stack at the fuel temperature pre-conditioner 20.

As shown in FIG. 1, the oxidant (e.g., air or oxygen) from the air source enters the air pre-heater at an oxidant inlet 60 of the air pre-heater 14, and exits the air pre-heater 14 at an air outlet 64 of the air pre-heater 14. The hot exhaust gas instead enters the air pre-heater 14 at a heat inlet 62 of the air pre-heater 14 and exits the air pre-heater 14 at the exhaust 66 of the air pre-heater, and is routed from the exhaust 66 to vent from the system 100 via the exhaust 24. While the air and the hot exhaust gas are in the air pre-heater, a heat exchanger of the air pre-heater facilitates exchange of heat between the exhaust gas and the air. Heat is transferred from the exhaust gas to the air so that the exhausted gas is cooled and the air for entry to the stack is warmed.

An air bypass 92 can be provided to allow the air (or oxidant or oxygen) to bypass the air pre-heater, and control valves 68, 70 may be provided to allow automated control of that bypass—the temperature of the air mixture fed into the stack 10 can thus be controlled by mixing hotter air from the air pre-heater with cooler air from the source, as necessary to provide air at the correct/desired temperature (or within a desirable range of temperatures) to the stack 10. In some embodiments, a control valve 70 is provided both upstream and downstream of the air pre-heater. In other embodiments a control valve 70 is only provided upstream of the air pre-heater and a mixer 68 is provided downstream thereof, or vice versa.

As shown in FIG. 1, the system 100 may additionally be provided with a fuel top-up 74 for the tail gas burner 12 so that if additional heat is required, additional fuel (or fuel and oxidant using separate respective top-up lines) can be delivered to the tail gas burner 12, e.g. via one or more top-up inlet 58 into the tail gas burner 12. This top up may be air from the air source 22 (e.g. via the stack, or via a bypass) or air or oxidant from elsewhere, and/or fuel from the ammonia source 26, or fuel from elsewhere.

Pipework connects the various schematically illustrated elements of this system 100, as schematically illustrated by the connecting lines in the drawings, although the specific configuration of the pipework can be routed differently as the specific locations of the components can vary between installations.

Referring next to FIG. 2, a modified version of the system of FIG. 1 is schematically shown. In this alternative configuration, a bypass for the cracker 18 is provided so that hot exhaust gas from the tail gas burner 12 can be redirected away from the cracker 18 and may optionally be routed to further equipment 78 that may require heat. In this embodiment the bypass uses a variable valve 80 to allow the feed volume or feed rate ratios of the hot exhaust gas to be controlled between the cracker 18 and the further equipment 78, although it might instead be a fixed valve (or more simply a fixed flow line).

Referring next to FIG. 3, another modified version of the fuel cell system 100 of FIG. 1 is schematically shown. It incorporates an alternative configuration for its fuel supply to its fuel cell stack 10, still with a fuel temperature pre-conditioner 20, but this time in the form of a fuel heater 20, rather than a pipe/heat exchanger around the stack 10. Furthermore, in this embodiment the fuel heater 20 additionally supplies heat to (or exchanges heat between) the fuel (the at least partially cracked ammonia from the cracker 18, via the fuel heat recuperator) for the stack 10 and (from) the oxidant (or air or oxygen) for the stack 10. For this purpose the fuel heater has a fuel inlet 94, a fuel outlet 96, an oxidant inlet 98 and an oxidant outlet 102. The fuel heater may be a heat exchanger for allowing heating of the oxidant and/or the fuel before entering the stack 10. The fuel heater may be a co-flow heat exchanger, which exchanges heat between the fuel (the at least partially cracked ammonia from the cracker 18) and the oxidant in order to ensure that the temperature of the fuel and oxidant at the fuel outlet 96 and oxidant outlet 102 (and therefore also at the respective stack inlets) are similar, which reduces thermal gradients in the stack and associated stresses.

In this embodiment, the air bypass 92 is again provided to bypass the air pre-heater, as before, but additionally a second air bypass 104 is provided—for bypassing both the air pre-heater 14 and the fuel heater 20. With suitable control valves for each of these air bypasses the temperature of the air entering the stack 10 and the temperature of the fuel entering the stack 10 can each be controlled independently as the temperature of the air entering the fuel heater can be controlled, and thus, in the case of a heat exchanger in the fuel heater 20, the output temperatures of the two fluids from the fuel heater 20 can also be controlled (increased or reduced). For example, in one embodiment, the heat exchanger in the fuel heater may operate in co-flow, whereby the heat exchanger's outlet temperatures would be coupled, i.e. approximately the same, and thus not independently controlled, but control could be reinstated at the stack inlets by bypass 104 allowing for decrease or increase of oxidant at the stack's oxidant inlet by adding to (or not) additional oxidant flow to that oxidant inlet—flow from the heat exchanger and flow through the bypass. As the temperature of the oxidant through the bypass will be below the temperature of the oxidant from the heat exchanger's oxidant outlet, this can be used to offset or control the mixed flow of oxidant at the stack's oxidant inlet, thus providing a controllable oxidant flow temperature at the stack's oxidant inlet.

Referring next to the embodiment represented by FIG. 4, the fuel cell system 100 of FIG. 1 is modified by replacing the separate cracker 18 and tail gas burner 12 with a combined catalytic combustion cracker 106. It is possible instead to provide the cracker and a separate catalytic combuster in place of a tail gas burner, but by combining the two, space can be saved.

In this embodiment, in place of flame combustion, catalytic combustion of the off-gases from the stack 10 is performed, whereby heat is produced and used by the cracker to provide energy for the cracking of the ammonia in the cracker (an endothermic process, thus needing heat to maintain its operation). Excess heat (hot exhaust gas from the combined catalytic combustion cracker 106) is still produced and thus this system can still be used to heat the air at the air pre-heater 14, as shown. Furthermore, as shown in FIG. 5, this can likewise be modified to put the fuel heater 20 corresponding to that of FIG. 3 in place of the pipe of FIG. 4 as the fuel temperature pre-conditioner 20—thus again heating or exchanging heat between the air and the fuel for the stack 10. In FIG. 5, to simplify the figure, the cracker and the fuel heat recuperator (which respectively feed fluids into the air pre-heater 14 and the fuel heater 20) are not shown. However, the output from the cracker (ExhCrkOut) is schematically shown entering the air pre-heater 14, the output from the fuel heat recuperator (FuelFhrOut) is shown schematically entering the stack (STK) 10, and the air input for the fuel cell (AirFcmIn) is schematically shown entering the air pre-heater 14.

Referring next to FIG. 6, a graphical representation of sample temperatures of the ammonia/cracked ammonia, as fed to and through an ammonia cracker 18, 106, from when it first passes into the fuel heat recuperator 16, through the ammonia cracker 18, 106 and again through the fuel heat recuperator 16, prior to passing to the stack 10, is shown. The graph represents a fuel heat recuperator cold side—to the left, which represents the fuel's first pass through the fuel heat recuperator (FHR 16), where the fuel heat recuperator (FHR 16) serves to prevent damage to the cracker (CRK 18) by increasing the input temperature of the fuel into the cracker, thus reducing thermal gradients across the cracker, a central or middle “cracking” phase, where the fuel temperature increases further (as it passes through the cracker 18), eventually reaching its peak temperature, and a fuel heat recuperator hot side—to the right, which represents the fuel's second pass through the fuel heat recuperator, which brings down the temperature of the (now cracked) fuel to an approximate “stack temperature”.

In more detail, in the cold side, the ammonia from the fuel source 26 is generally starting at room/ambient temperature—around 20 degrees C. That fuel increases in temperature at a relatively steady rate as it passes through the fuel heat recuperator 16 for the first time as the fuel heat recuperator is preferably of a cross-flow type, as will be explained below with reference to FIG. 8.

The rate of increase in temperature then gradually starts to increase again as the fluid passes through the cracker 18, 106. Despite the cracking process being endothermic, the temperature rises slowly due to the supplied heat from the tail gas burner/catalytic combustion. However, the effect of the endothermic reaction becomes less as the parts per million (ppm) of ammonia, and thus the cracking activity, drops. The cracked fuel thus starts to heat more quickly later on.

To maximise the effect of heat supply to the gas at the start of the cracking process, for better countering the endothermic effect of the cracking process in the cracker 18, 106, a skilled person might initially think that they need the cracker 18, 106 to operate as a co-flow heat exchanger, in the system. However, where the temperature of the exhaust gas from the heat source is insufficiently higher than the target operational temperature of the cracker for achieving the desired degree of cracking of the ammonia (e.g. 700 degrees C for achieving <1000 ppm ammonia), a counter-flow heat exchanger instead becomes preferable. In the case of a heat source using the off-gas from the stack 10 in an IT-SOFC, where the stack's operating temperature is usually around 600 degrees C, the heat source temperature would likely be insufficiently higher than that target cracking temperature, and thus in a preferred aspect of the present invention the cracker 18, 106 is made with a counter-flow heat exchanger, rather than a co-flow heat exchanger. In other words, use of a counter-flow heat exchanger maximises the maximum temperature on the fuel side of the heat exchanger, which is favourable for maximising the proportion of ammonia cracked in the cracker 18, 106.

The fluid (now the at least partially cracked ammonia fuel) then exits the cracker 18, 106 and returns to the other side of the fuel heat recuperator 16 to steadily reduce in temperature as it heats up the incoming ammonia. As shown, the ammonia gas fed into the cracker peaks at 700 degrees C in this example as at that temperature the ammonia cracker 18, 106 can achieve the targeted less than 1000 ppm of ammonia in the output gas flow (i.e. for the at least partially cracked ammonia fuel exiting the cracker 18). It then drops to around 300 degrees C when it re-exits the fuel heat recuperator 16 as its heat is transferred to the source gas. Due to that temperature drop it will need to be reheated again before entering the stack 10 to, for example, a target temperature of around 450 degrees C for an intermediate temperature solid oxide fuel cell system (e.g. a metal supported solid oxide fuel cell system). For that the fuel heater or fuel temperature pre-conditioner 20 is used, which instead is preferred to be a co-flow heat exchanger for more-or-less equalising the temperatures of the respective flows therethrough.

It is to be understood that the above temperatures are only provided as examples. Different temperatures—higher or lower—might also be used. For example, the actual temperatures can vary dependent on the size or efficiency of the respective heat exchangers, the specifics of the catalyst used for cracking (and therefore the temperature required) and also the relative flow rates/heat transfer rates of the fluids and components of the system.

Referring next to FIGS. 7 and 8, there is schematically shown the relative operational fluid temperatures of fluids passing through a co-flow heat exchanger and a counter-flow heat exchanger, respectively.

In a co-flow heat exchanger, as shown in FIG. 7, the two fluids rapidly start to increase/reduce in temperature, but as their temperatures approach one another (i.e. equalise), the rate of change in temperature reduces. This characteristic makes a co-flow heat exchanger potentially more appropriate for an ammonia cracker as it could better counter the peak endothermic effect at the start of the cracking process, and thus while there is a high degree of cracking taking place. A trade off with co-flow heat exchangers, however, is that a median temperature for both fluids is ultimately achieved, whereby a lot of heat from the heat source is necessary to achieve, for example, a desirable 700 degrees C for the ammonia gas product at exit from the cracker 18 (as with the present invention a low parts-per-million of ammonia in the fluid exiting the cracker is targeted). As a tail gas burner or a catalytic combustion using the off-gases of the stack 10 may struggle to provide such a continuous high temperature (and in particular without a need for top-up fuel/oxidant, although top-up fuel/oxidant can be provided if needed), the present inventors have realised that this co-flow arrangement in practice is less optimum than a counter-flow arrangement.

FIG. 8 shows a counter-flow arrangement, and the temperature characteristics of the fluids in such a heat exchanger. As shown, this instead shows generally linear rates of change of temperature, and the exchange heat between the two fluids results in a first fluid exiting the heat exchanger at a similar temperature to that which the second fluid entered the heat exchanger (as an approximation, under certain assumptions such as if the two fluids had similar properties other than temperature). This is good for pre-heating the ammonia before it enters the cracker 18, 106, as the ammonia can then be infed into the cracker at a high temperature (for example 500 degrees C) as a result of heat exchange (at the fuel heat recuperator 16) between the at least partially cracked ammonia and the raw ammonia input. It should be noted that this is beneficial since ammonia crackers, or heat exchangers in general, can have a short working life if exposed to high levels of thermal stress (e.g. by way of infeed temperatures of the ammonia relative to the infeed from the heat source being widely different). It also allows the heat from the tail gas burner or the catalytic combuster to be used as the heat source as the heat source need not be significantly hotter than the target cracker temperature.

The present invention thus preferably uses a counter-flow heat exchanger in the cracker 18.

Referring next to FIG. 10 there is schematically shown a graphical representation over time of various exemplary inputs and outputs to or from the fuel cell system 100 of the present invention, such as fluid flow rates, temperatures and electrical currents, during system start-up or during a warm-up cycle.

As can be seen in FIG. 10, at t=0, there is no airflow 108, the stack air inlet temperature 110 is at its minimum, there is no stack current 112, the stack fuel flow rate 114 (fuel flow rate to the stack) is zero, the temperature at the exit of the cracker (tExhCrkOut) 118 is at its minimum and the stack air outlet temperature 120 is at its minimum.

From t=0, the stack is heated with a heater (an electric heater or combustion of a hydrocarbon fuel at a burner in a manner that will be known to the skilled person, and which may be the tail gas burner 12 or catalytic combuster 106), and oxidant or air is flowed through the system 100, which allows the heater to provide heat which flows through the system, heating the cracker 18 and the stack 10, as signified by the increasing temperature at the exit of the cracker (tExhCrkOut) 118 and of the stack air inlet temperature 110 and the stack air outlet temperature 120. Indeed, there is a steep increase of air and fuel flow at the start, with the airflow then achieving a steady state, and maintaining that steady state even once the fuel cell system 100 achieves its full operational temperature.

At the same time, the stack 10 can start to be fed fuel, as signified by the increase in the stack fuel flow rate 114, caused by feeding ammonia into the cracker 18 through the fuel heat recuperator 16. This creates an initial variation in the cracker's outlet temperature 118, and a reactionary flow rate change in the stack fuel supply 114. Meanwhile the stack air outlet temperature continues to increase. Once that hits around 500 degrees C, for an IT-SOFC—current 112 can start to be drawn as the electrochemically active layers 88 in the fuel cells 82 of the stack 10 will have reached an operational temperature. Other temperatures may instead apply, depending upon the form/chemistry of the fuel cell. Meanwhile the fuel flow rate to the stack may achieve a steady state. The stack air inlet temperature 110 and the cracker outlet temperature 118 can also stabilise, although as shown these may still vary for an extended period of time due to variations of electrical load on the stack.

During this warm-up/start-up cycle, it is preferred that the cracker be warmed slowly to avoid excessive thermal shock to the components thereof. In the example of FIG. 10, the rate of increase in temperature of the cracker 18 is limited—for example by increasing/reducing the air flow through the stack 10, or with a bypass 92 of the air pre-heater 14, or by an additional bypass line 122 that also bypasses the stack 10 and the tail gas burner 12, such that the cracker's outlet temperature 118 increases at a similar rate to the stack 10. For example, in some embodiments, it does not increase by more than, for example, 25 degrees C per minute.

Referring next to FIG. 11 there is schematically shown a modified configuration for the fuel cell system 100 of FIG. 1 during the system start-up or warm-up cycle above in which the additional bypass line 122 is shown. As can be seen, the system 100 still has the air pre-heater 14, the stack 10, the tail gas burner 12, the fuel heat recuperator 16 and the cracker 18. It also has the bypass 92 for selectively bypassing the air pre-heater 14. However, there is the additional bypass line 122 for allowing air to be passed from the air source 22 directly into the outflow from the tail gas burner. As the air from the air source has a typical temperature of 20-25 degrees C, whereas the exhaust from the tail gas burner typically has a temperature of about 750 degrees C, it is possible to reduce the temperature of the gas feeding into the cracker's heat inlet 38. Further control is also possible with the previously described variable valve 80, which can divert some of the gas flow from the tail gas burner (or heater) away from the cracker along a cracker bypass line 124, as discussed previously in respect of the embodiment of FIG. 2. That variable valve 80, may provide a heat bypass upstream of the point of insertion of the additional bypass line 122 for the air, as shown, as that should be more efficient than positioning it after it—by avoiding some of the effect of the heat on that additional air.

Referring next to FIG. 12 there is schematically shown a modified configuration for the fuel cell system of FIG. 3 in which an exemplary anode off-gas recirculation path 202 is provided. The anode off-gas recirculation path 202 is configured to recycle a portion of the off-gas from the anode off-gas outlet of the stack 10 to the anode inlet of the stack 10. Off-gas from the anode off-gas outlet of the stack 10 may contain unused cracked fuel gas, which may be recirculated in the anode off-gas recirculation path 202 for use by the stack 10.

In the example of FIG. 12, the anode off-gas recirculation path 202 joins the anode inlet gas fluid flow path at a mixer 214 between the (outlet of the) recuperative heat exchanger (fuel heat recuperator 16) and the (inlet of the) air pre-heater 14. The portion of off-gas from the anode off-gas outlet of the stack 10 is directed into the anode off-gas recirculation path 202 at a splitter 204. Said splitter 204 may direct a fixed or variable (i.e., controlled) portion of the anode off-gas into the anode off-gas recirculation path 202, the remainder being provided to the heat source 12 (tail gas burner 12) as previously described.

As shown in FIG. 12, the anode off-gas recirculation path 202 may further comprise, sequentially, an anode off-gas condenser heat exchanger 206, a pump 210, and a getter 212. The anode off-gas condenser heat exchanger 206 is configured to cool the anode off-gas in the anode off-gas recirculation path 202 by heat transfer with air or oxidant 22. The anode off-gas condenser heat exchanger 206 is located upstream of the air pre-heater 14 in the air inlet fluid flow path. Bypass paths 92 and/or 104 may also bypass the anode off-gas condenser heat exchanger 206. The anode off-gas condenser heat exchanger 206 is configured to condense water 208 out of the anode off-gas, which may be used elsewhere in the system or routed out of the system. The pump 210 is configured to pump anode off-gas around the anode off-gas recirculation path 202. The getter 212 is configured to remove ammonia from anode off-gas in the anode off-gas recirculation path 202. In this way, the proportion of ammonia in the anode off-gas recirculation path 202 is reduced or eliminated, while cracked but unused fuel gas is retained, resulting in a reduced proportion of ammonia in the anode inlet gas fluid flow path downstream of the mixer 214 and in the stack 10.

In this example, the getter 212 is a low temperature getter (for example operable at a temperature of approximately 100 degrees C or lower). Use of a higher temperature getter is also possible, in which case the anode off-gas condenser heat exchanger 206 may not be present, but the pump 210 would be subject to higher temperature operation. While the anode off-gas recirculation path 202 has been described as a modification to the system of FIG. 3, it will be understood that the anode off-gas recirculation path 202 may similarly be used in conjunction with the exemplary systems described with reference to FIGS. 1, 2, 4, 5, and 11.

In the above description of FIGS. 1-12, the fuel gas is exemplified as ammonia and the cracker as having a catalyst suitable for ammonia cracking. The arrangements described may equally be used for other fuel gases for which it is advantageous to crack the fuel gas to an at least partly cracked fuel gas for delivery to the anode inlet of the at least one fuel cell stack. Methane and higher hydrocarbons may be cracked in the arrangement described. For example, the fuel gas may be (or may contain) a methanol-containing fuel gas, in which case the cracker may be provided with a catalyst suitable for methanol cracking. In this case, cracking of the methanol-containing fuel prior to delivery to the anode inlet of the at least one fuel cell stack reduces coking in the at least one fuel cell stack. Such methanol cracking may be used in an intermediate or high-temperature fuel cell system. However, for some methanol cracking catalysts such high grade heat (as found in those systems) is not necessary. For this reason the described fuel cell systems are particularly useful for cracking methanol in PEM fuel cell systems whose stacks operate at a relatively low (or lower) temperature but whose heat source can be used to provide sufficient heat for methanol cracking in the arrangements described herein.

It will be appreciated that the arrangements described herein are applicable to other fuel gases, for example methane and higher hydrocarbons, and ethanol and higher alcohols.

Certain embodiments of the present invention have therefore been described above with reference to the accompanying drawings, purely by way of example. Modifications in detail to each of these embodiments may be made without departing from the scope of the invention, as defined in the claims as appended hereto.

1. A fuel cell system comprising:
(i) at least one fuel cell stack comprising at least one fuel cell, and having an anode inlet, a cathode inlet, an anode off-gas outlet, and a cathode off-gas outlet;
(ii) a cracker for cracking a fuel gas to an at least partly cracked fuel gas, and having a cracker inlet for receiving the fuel gas, and a cracker outlet for exhausting the at least partly cracked fuel gas;
(iii) a recuperative heat exchanger; and
(iv) a heat source;
wherein:
a) the system defines an anode inlet gas fluid flow path for delivering a fuel gas from a first inlet of said recuperative heat exchanger to a first outlet of said recuperative heat exchanger, through said cracker, to a second inlet of said recuperative heat exchanger, to a second outlet of said recuperative heat exchanger and to said anode inlet of the at least one fuel cell stack;
b) the heat source is configured to provide heat to the anode inlet gas fluid flow path between the first outlet of said recuperative heat exchanger and the second inlet of said recuperative heat exchanger; and
c) said recuperative heat exchanger is arranged to transfer heat from relatively higher temperature at least partly cracked fuel gas from the cracker outlet to relatively lower temperature fuel gas delivered between the first inlet and the first outlet of the recuperative heat exchanger, so as to raise the temperature of fuel gas delivered between the first inlet and the first outlet of the recuperative heat exchanger for delivery to the cracker inlet, whilst reducing the temperature of the at least partly cracked fuel gas from the cracker, between the second inlet and the second outlet of the recuperative heat exchanger for delivery to the anode inlet.

2. The fuel cell system of claim 1, wherein the heat source comprises a tail gas burner of the fuel cell system.

3. The fuel cell system of claim 1, wherein the heat source comprises a catalytic combuster of the fuel cell system.

4. The fuel cell system of claim 1, wherein the heat source is a catalytic combustion cracker heat exchanger (CCCHX) configured to catalytically combust off-gases from the anode off-gas outlet and the cathode off-gas outlet, the CCCHX having a catalyst for cracking fuel gas coated on the anode inlet gas fluid flow path of the CCCHX and having a catalyst for catalytic combustion of off-gas from the anode off-gas outlet and the cathode off-gas outlet on the off-gas fluid flow path of the CCCHX, the catalytic combustion configured to provide the heat source for cracking the fuel gas.

5. The fuel cell system of claim 1, wherein the cracker comprises a second heat exchanger.

6. The fuel cell system of claim 5, further comprising:
a second gas fluid flow path, the heat source configured to provide heat to the second gas fluid flow path, wherein the fuel cell system is arranged to transfer heat from the second gas fluid flow path to the anode inlet gas fluid flow path, so as to provide energy for cracking,
wherein the second gas fluid flow path comprises an off-gas fluid flow path from the anode off-gas outlet and the cathode off-gas outlet of the stack to the heat source to the cracker, and
wherein the cracker has a catalyst for cracking fuel gas provided on one side of the second heat exchanger, which catalyst forms part of the anode inlet gas fluid flow path.

7-9. (canceled)

10. The fuel cell system of claim 1, wherein the anode inlet gas fluid flow path further comprises a pipe from said recuperative heat exchanger to the anode inlet, the pipe configured for heat exchange between the at least partly cracked fuel gas and one or both of:
the at least one fuel cell stack, and
the heat source.

11. The fuel cell system of claim 1, wherein a bypass or variable valve to provide flow control is provided between the heat source and the cracker for bypassing or reducing/varying flow of heat from the heat source to the cracker.

12. The fuel cell system of claim 11, wherein there is provided the bypass from the heat source, provided to allow at least a portion of the heat from the heat source to be diverted for alternative operations, or to entirely bypass heating the anode inlet gas fluid flow path within the cracker.

13. The fuel cell system of claim 1, wherein the fuel gas is an ammonia-containing fuel gas,
wherein the cracker comprises a second heat exchanger, and
wherein the cracker has a catalyst for cracking ammonia provided on one side of the second heat exchanger, which catalyst forms part of the anode inlet gas fluid flow path.

14. (canceled)

15. The fuel cell system of claim 1, wherein the fuel gas is a methanol-containing fuel gas, wherein the cracker comprises a second heat exchanger, and
wherein the cracker has a catalyst for cracking methanol provided on one side of the second heat exchanger, which catalyst forms part of the anode inlet gas fluid flow path.

16. (canceled)

17. The fuel cell system of claim 1, further comprising an anode off-gas recirculation path configured to recycle a portion of anode off-gas from the anode off-gas outlet of the at least one fuel cell stack to the anode inlet of the at least one fuel cell stack.

18. The fuel cell system of claim 17, wherein the anode off-gas recirculation path comprises a getter configured to remove uncracked fuel gas from the anode off-gas recirculation path.

19. A method of at least partially cracking fuel gas, comprising providing a system according to any one of the preceding claims, flowing fuel gas through the anode inlet gas fluid flow path, and providing heat via the heat source to the anode inlet gas fluid flow path between the first outlet of said recuperative heat exchanger and the second inlet of said recuperative heat exchanger.

20. The method of claim 19, wherein the heat source is configured to combust off-gases from the anode off-gas outlet and the cathode off-gas outlet, and the off-gas fluid flow path is configured to route combusted off-gas to the cracker at a relatively higher temperature than the fuel gas, the cracker being configured to transfer heat from the relatively higher temperature combusted off-gas to the relatively lower temperature fuel gas.

21. The method of claim 19, wherein there are three stages of heat exchange—heat exchange from the heat source to the fuel gas, heat exchange to the supply of fuel gas as fed between the first inlet and the first outlet of the recuperative heat exchanger by the relatively higher temperature at least partly cracked fuel gas from the cracker outlet, and heat exchange to cool that relatively higher temperature at least partly cracked fuel gas by the supply of fuel gas as fed between the first inlet and the first outlet of the recuperative heat exchanger.

22. The method of claim 19, wherein the fuel gas is an ammonia-containing fuel gas, the method is at a method of at least partially cracking ammonia into nitrogen gas and hydrogen gas, and the cracker has an operational temperature of between 550 degrees C and 900 degrees C.

23. (canceled)

24. The method of claim 19, wherein the fuel gas is a methanol-containing fuel gas, the method is at a method of at least partially cracking methanol into carbon dioxide gas and hydrogen gas, and the cracker has an operational temperature of between 250 degrees C and 450 degrees C.

25. (canceled)

26. A method of start-up of a fuel cell system, the fuel cell system comprising:
at least one fuel cell stack with an oxidant inlet and a fuel inlet,
an oxidant heat exchanger for an oxidant flow to the oxidant inlet of the stack,
a heat source for heating the at least one fuel cell stack, and
a cracker for cracking a fuel gas to an at least partly cracked fuel gas, the cracker having a cracker inlet for receiving the fuel gas and a cracker outlet for exhausting the at least partly cracked fuel gas for feeding to the fuel inlet of the stack,
the method comprising:
heating the at least one fuel cell stack to a first threshold temperature; and
once the at least one fuel cell stack reaches a first threshold temperature, either commencing or increasing a rate of a flow of the fuel gas to the cracker.

27. (canceled)

28. The method of claim 26, wherein the oxidant is provided to the heat source via an oxidant fluid flow path from an oxidant source to the stack's oxidant or cathode inlet, through the stack and out from the stack's cathode off-gas outlet to the heat source.
